(19) United States
(12) Patent Application Publication
(10) Pub. No.: US 2026/0057185 A1
(43) Pub. Date: Feb. 26, 2026

(54) CALL ANALYSIS SYSTEMS AND METHODS

(71) Applicant: Royal Bank of Canada, Toronto (CA)

(72) Inventors: Aksh Patel, Edmonton (CA); Samhith Sripada, Oakville (CA); Sarah You, Richmond Hill (CA); Owen Cooke, St. Albert (CA)

(21) Appl. No.: 19/278,119

(22) Filed: Jul. 23, 2025

Related U.S. Application Data
(60) Provisional application No. 63/685,396, filed on Aug. 21, 2024.

(51) Int. Cl. G06F 40/35; G10L 15/26

(52) U.S. Cl. CPC G06F 40/35; G10L 15/26

(57) ABSTRACT

Methods, systems, and techniques for call analysis are disclosed, comprising receiving transcription data for a call; providing the transcription data to a large language model with an associated prompt to generate a summary of the call based on the transcription data; and receiving the summary of the call output from the large language model.

### CROSS-REFERENCE TO RELATED APPLICATIONS

This application claims priority to United States Provisional Ser. No. 63/685,396, filed on Aug. 21, 2024, the entire contents of which are incorporated herein by reference for all purposes.

### TECHNICAL FIELD

The present disclosure is directed at methods, systems, and techniques for call analysis.

### BACKGROUND

Meetings involve the exchange of information between individuals, which is difficult to meaningfully capture. Individuals partaking in a meeting may take meeting minutes to record important information from a meeting, and/or technologies may be used to generate transcripts of a meeting, but the recorded information may be inaccurate and/or incomplete and may be of limited use for relevant stakeholders.

Accordingly, information loss occurs, which is a major concern for organizations and inhibits decision-making capabilities. For example, in the context of incident resolution and problem management processes, information loss occurs because such information is documented post-mortem manually. This results in poor or inaccurate recording of information to address the problem and/or resolve the incident, and thus serves as an inadequate reference when addressing future problems/incidents. It would thus be desirable to accurately and contextually capture information that is exchanged during meetings.

### SUMMARY

According to a first aspect of the present disclosure, there is provided a call analysis method, comprising: receiving transcription data for a call; providing the transcription data to a large language model with an associated prompt to generate a summary of the call based on the transcription data; and receiving the summary of the call output from the large language model.

In some aspects, the transcription data is received in real-time during the call.

In some aspects, the transcription data comprises text snippets corresponding to spoken words during the call and an associated user identifier corresponding to a participant in the call.

In some aspects, the transcription data comprises a batch of transcription data that is batched based on a batch time period or a batch data size.

In some aspects, the batch of transcription data is sent to the large language model upon creation of the batch.

In some aspects, the batch of transcription data is created in real-time during the call.

In some aspects, the method further comprises providing a plurality of batches of transcription data to the large language model, and receiving a plurality of summaries of the call based on the plurality of batches of transcription data.

In some aspects, the plurality of batches of transcription data are provided to the large language model sequentially upon creation of respective batches of transcription data.

In some aspects, the method further comprises prompting the large language model to generate an executive summary of the call based on the plurality of summaries of the call.

In some aspects, the method further comprises verifying the summary of the call by providing the summary of the call back to the large language model with questions for factualness verification and summary refining.

In some aspects, the method further comprises displaying the summary of the call in near-real-time in a user interface.

In some aspects, the method further comprises providing multimodal inputs to the large language model along with the transcription data for generating the summary of the call.

In some aspects, the call is an incident resolution call.

In some aspects, the method further comprises determining, using the large language model, one or more incident resolution events, and generating a timeline of the one or more incident resolution events.

In some aspects, the method further comprises storing the summary of the call in a database.

In some aspects, the call takes place on an online meeting platform.

In some aspects, the transcription data is received from a transcription application.

According to another aspect, there is provided a call analysis system, comprising: a processor; and a non-transitory computer-readable memory having computer-executable instructions stored thereon, which when executed by the processor, configure the system to perform the call analysis method of any one the above aspects.

According to another aspect, there is provided a non-transitory computer-readable memory having computer-executable instructions stored thereon, which when executed by a processor, configure the processor to perform the call analysis method of any one of the above aspects.

This summary does not necessarily describe the entire scope of all aspects. Other aspects, features and advantages will be apparent to those of ordinary skill in the art upon review of the following description of specific embodiments.

### BRIEF DESCRIPTION OF THE DRAWINGS

In the accompanying drawings, which illustrate one or more example embodiments:

FIG. 1 shows a representation of a call analysis system;

FIG. 2 shows a representation of hardware components of an application server;

FIG. 3 shows an architecture diagram of the call analysis system;

FIG. 4 shows a process flow diagram of the call analysis system;

FIG. 5 shows an example of a user flow diagram of how a user interacts with the call analysis system;

FIGS. 6A-E show examples of user interfaces that may be displayed by the call analysis system; and

FIG. 7 shows a call analysis method.

### DETAILED DESCRIPTION

Call analysis systems, methods, and techniques are disclosed that provide a call summary tool that acts as a summarization engine to capture verbal context from a call in real-time and aids in documenting the contents of the call. The call summary tool may in particular be used to summarize problem-solving discussions, such as IT incident responses (e.g. responding to incidents caused by saturated CPUs, software updates, etc.), to document key events such as attempted solutions, a determination of a root cause of the incident, a successful solution to address the incident, etc. The call summary tool sits in a meeting platform that facilitates online meetings/calls (e.g. Webex™ calls) and receives live transcriptions as individuals are having conversations. These transcriptions are sent to a Large Language Model (LLM) Gateway and asks the LLM Gateway, with given prompts, to summarize the call that is taking place. The LLM produces summaries of the call. These summaries from the LLM may be uploaded to a frontend of the call summary application for users to see a summary of the ongoing call and a timeline of key events that have happened. The entire process is performed in real-time from context capture to summary output for users.

The call summary tool makes it easy for teams within organizations to document discussions and assists with reporting key insights to stakeholders. The call summary tool turns speech-to-text transcription from calls into summaries and insights, which may for example be specifically tailored towards technical incident and problem management. The call summary tool may maintain a key event timeline, generate a summary of the ongoing discussion, etc., and can thus be used to analyze conversations for post-discussion learning. In particular implementations, the call summary tool may be used for analyzing calls relating to incidents, and the post-discussion learning can be used to learn how to identify root causes and remedial actions to deal with similar incidents in the future. Accordingly, the call summary tool aids in critical problem solving and decision making, reducing cognitive load, toil, and improving the gathering of information on bridge calls. The call summary tool may store the call data and associated processed data (call summaries, inferences, etc.), thus providing a high-quality data foundation for teams to build preventative incident systems utilizing AI enabled tools.

The call summary tool provides technical advantages including that information is captured automatically without manual intervention and interaction required from users, which improves the accuracy, completeness, and quality of the data collected. Moreover, being able to automatically capture and analyze transcription data provides improved computer functionality and also represents a technical improvement to the practical application of analyzing calls. The call summary tool thus helps to solve problems of information loss and context switching during calls among multiple application teams and stakeholders. The collected incident data benefits the stakeholders in real-time and provides an organization with a large, high quality knowledge base to enable preventative systems in the future.

In at least some embodiments herein, methods, systems, and techniques for call analysis are disclosed, comprising receiving transcription data for a call; providing the transcription data to a large language model with an associated prompt to generate a summary of the call based on the transcription data; and receiving the summary of the call output from the large language model.

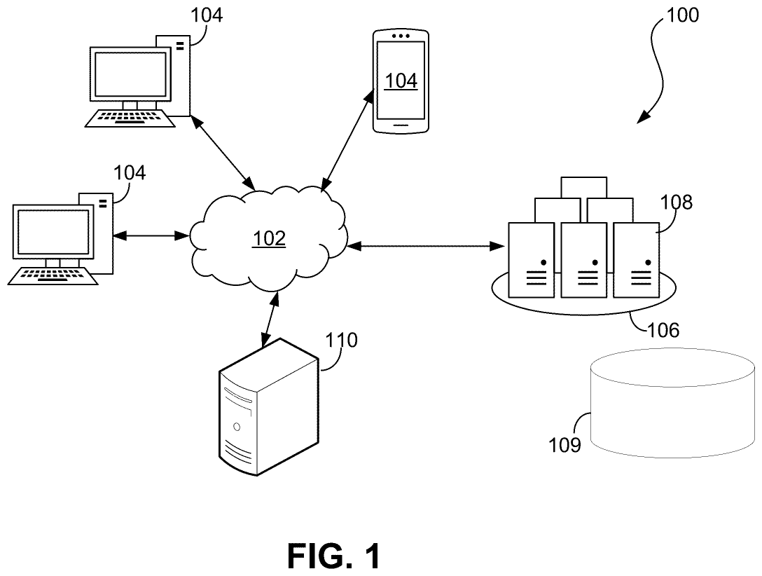

Referring now to FIG. 1, there is shown a computer network 100 that comprises an example embodiment of a call analysis system. More particularly, the computer network 100 comprises a wide area network 102 such as the Internet to which various user devices 104, data center 106, and one or more third party servers 110 are communicatively coupled. The data center 106 comprises a number of servers 108 networked together to collectively perform various computing functions including call analysis as disclosed herein. The servers 108 may be distributed (cloud service). In accordance with the present disclosure, the data center 106 is configured to analyze calls (e.g. audio/video calls between user devices 104) to generate a summary of the calls in near-real-time based on live transcription data. The data center 106 further comprises a data storage 109 storing the results of the call analysis, including call summaries, call events/timeline, etc.

In accordance with the present disclosure, when users of user devices 104 have a call and/or participate in a web-based meeting over network 102, the servers 108 are configured to receive live transcription data for the call, provide the transcription data to a large language model with an associated prompt to generate a summary of the call, and receive a summary of the call output from the large language model, which can then be displayed to the one or more users of user devices 104 in near-real-time. The summary of the call, along with other determinations from the call analysis such as key events, can be stored in the database 109 for future reference. The servers 108 may execute the large language model, or the one or more third party servers 110 may include server(s) that execute the large language model, for example.

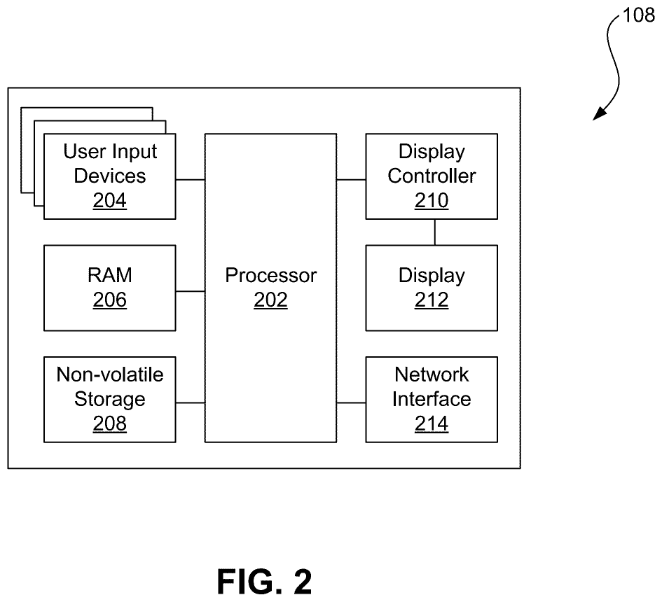

Referring now to FIG. 2, there is depicted an example embodiment of one of the servers 108 that comprises the data center 106. The server comprises a processor 202 that controls the server's 108 overall operation. The processor 202 is communicatively coupled to and controls several subsystems. These subsystems comprise user input devices 204, which may comprise, for example, any one or more of a keyboard, mouse, touch screen, voice control; random access memory (“RAM”) 206, which stores computer program code for execution at runtime by the processor 202; non-volatile storage 208, which stores the computer program code executed by the RAM 206 at runtime; a display controller 210, which is communicatively coupled to and controls a display 212; and a network interface 214, which facilitates network communications with the wide area network 104 and the other servers 108 in the data center 106. The non-volatile storage 208 has stored on it computer program code that is loaded into the RAM 206 at runtime and that is executable by the processor 202. When the computer program code is executed by the processor 202, the processor 202 causes the server 108 to implement a method for call analysis as is described in more detail herein. Additionally or alternatively, the servers 108 may collectively perform that method using distributed computing. While the system depicted in FIG. 2 is described specifically in respect of one of the servers 108, analogous versions of the system may also be used for the user devices 104.

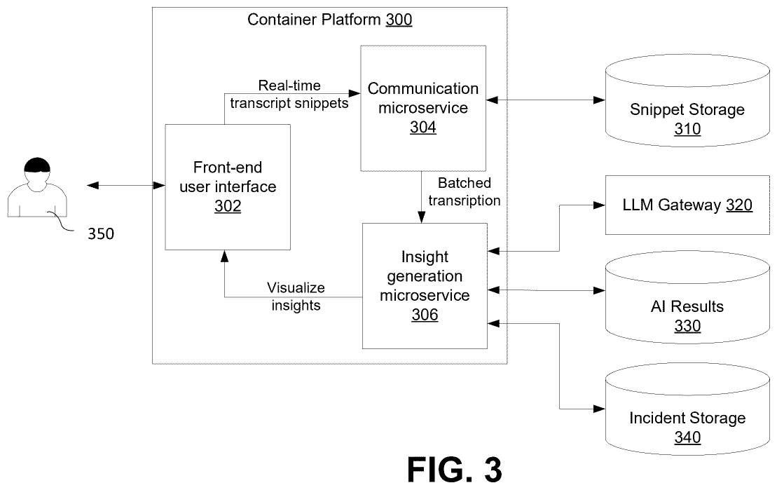

FIG. 3 shows an architecture diagram of the call analysis system. The call analysis system combines integrations from multiple services (e.g. Webex™, OpenAI™, and ServiceNow™) together to create a customized approach to capturing and analyzing call data, in particular for incident resolution context. While the following description describes specific examples of platforms/tools used to implement the call analysis system and/or that integrate with the call analysis system, it will be appreciated that other platforms/tools may be used as well.

The call analysis system provides a call analysis tool within container platform 300 that comprises three major services that operate cyclically together: a front-end user interface 302, a communications microservice 304, and an insight generation microservice 306. The container platform 300 may for example be implemented using Openshift ™. The front-end user interface 302 may for example be implemented using a React™ user interface, a reverse proxy server, and an appropriate browser SDK for the meeting platform (e.g. Webex™). The communications microservice 304 may for example be implemented using FastAPI™. The insight generation microservice 306 may for example be implemented using FastAPI™ and LangChain™.

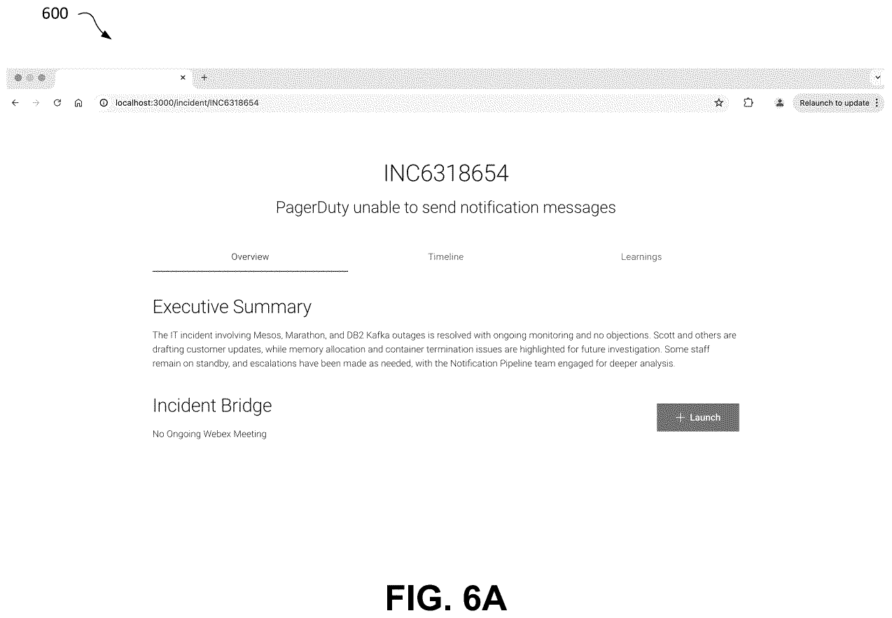

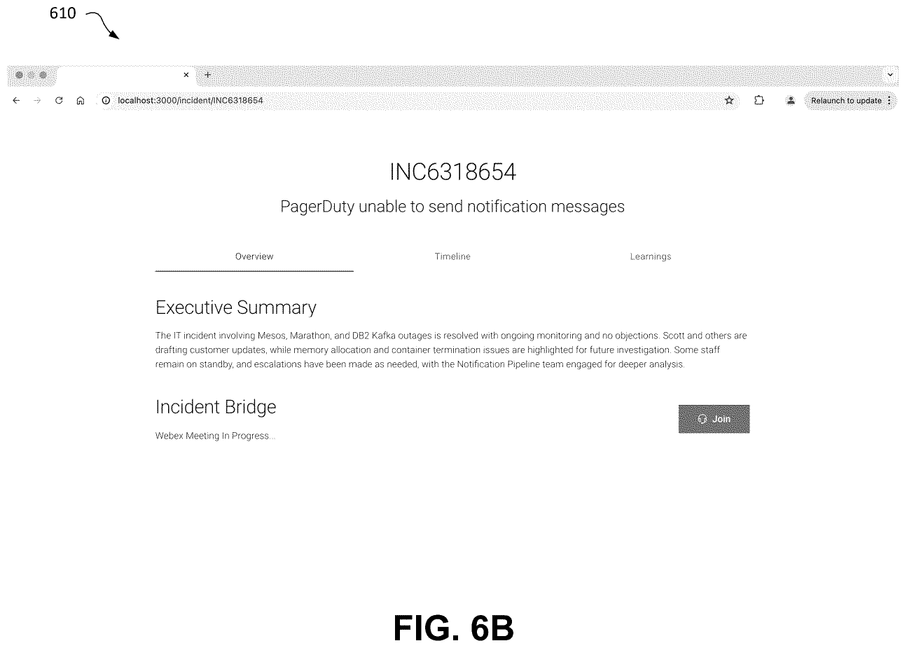

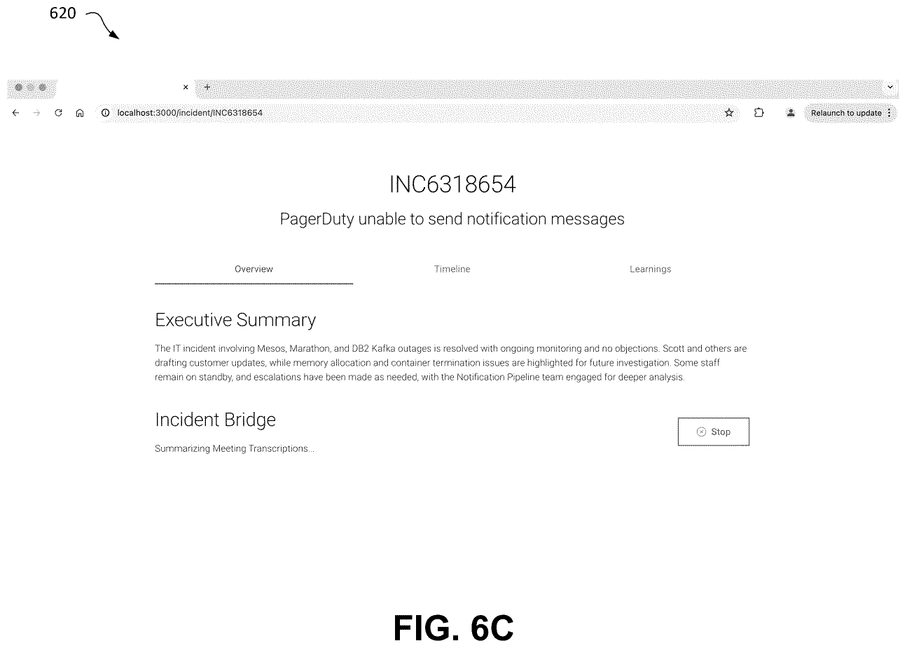

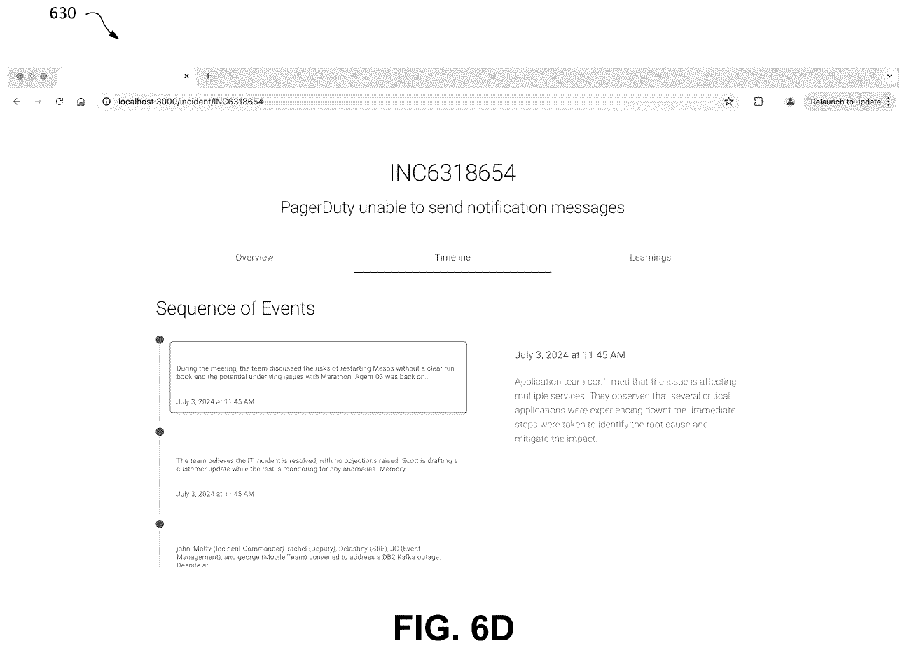

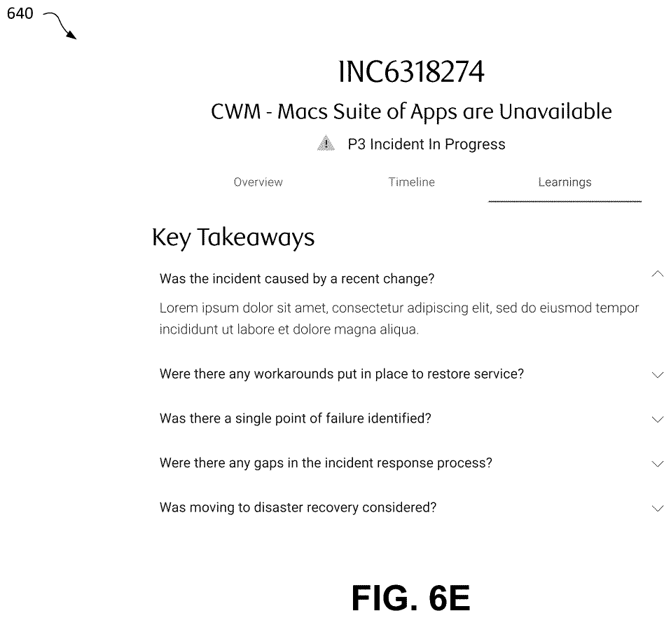

The front-end user interface 302 displays various information to a user 350. In the example of incident resolution calls, the front-end user interface 302 may display information including but not limited to technical incident data, a high-level status summary, and a timeline of the key events captured during incident communication. The user interface also facilitates the creation of a meeting (e.g. Webex™) call using the appropriate browser SDK, which for example application teams can initiate to troubleshoot and resolve incidents. Examples of user interfaces are described further herein with reference to FIGS. 6A-E.

Upon clicking a button to create a meeting, an authorization integration (e.g. Webex OAuth) may be used to authenticate the user 350, obtain their personal meeting room, and tie it to the incident number. The user 350 is redirected to join the meeting while the SDK joins as the call analysis tool, which listens for transcriptions throughout the meeting call. The transcriptions may be generated using a transcription application, such as Webex Assistant, for example. As application teams work to resolve the incident while in the call, the details of their efforts are captured by the transcription in real-time. Transcript snippets contain text snippets corresponding to spoken words during the call and an associated user identifier corresponding to a participant in the call

Real-time transcript snippets captured by the SDK event listeners are passed to the communication microservice 304, for example using a WebSocket, which batches the small, individual transcript snippets into longer conversations. The batching of the transcription data may be based on a batch time period (e.g. over intervals of 5 minutes) or a batch data size, and may implement a Redis cache for intermediate event storage. The batching may be done in server memory. Once the batch of transcripts has exceeded the threshold (time or data size), subsequent snippets may be concatenated if they share the same speaker id, and the batch is ready for processing. The transcript snippets and batches of transcription data may be stored in a database 310.

The batched transcription data is forwarded to the insight generation microservice 306, which utilizes a Generative AI LLM Gateway 320 to access a LLM, such as OpenAI's GPT4 model, for call summarization, insight generation, and validation. Using prompt engineering, content generated by the LLM Gateway 320 is standardized using a series of prompts, as described in more detail below. The prompts may include system-defined personas to tailor the gateway to respond with a degree of technicality appropriate to that of an IT incident scribe, and the implementation of Chain-of-Verification to validate generated responses and minimize instances of hallucination. The prompts may be packaged and executed through LangChain. The results from the Generative AI LLM, including call summaries, incident status, and key events for the incident based on the latest processed transcription batch are stored in an AI Results database 330, which may for example be implemented as a MongoDB. Incident data may be pulled from and updated in an Incident Storage database 340, which may for example be a ServiceNow™ replica database.

The front-end user interface 302 listens for updates from the incident generation microservice 306, for example using a WebSocket and Motor, an asynchronous Python driver for MongoDB. When a new status and key event are generated, they are automatically updated on the React frontend in real-time for the users observing the incident resolution process.

Accordingly, the call analysis system as described above can be used to provide several advantageous features including but not limited to:
(1) Creating an online meeting with authentication to a personal meeting room and automatically join the call with the user and the call analysis tool;
(2) Performing real-time conversation capturing and summarization during the meeting, by: (a) using a captioning service from the meeting platform to get transcription data; (b) batching these transcriptions into smaller documents and sending them to the LLM Gateway for summarization by the LLM (e.g. OpenAI GPT4 Turbo LLM); (c) asking the LLM to summarize the transcription using prompt engineering from a particular perspective (e.g. that of an IT support scribe); (d) upon receipt of the preliminary summary, asking the LLM to verify the factualness of the summary by referring only to events captured in the raw transcription; and (e) displaying details from the LLM on the frontend in near-real-time (e.g. within minutes (preferably between 1-2 minutes) between fetching transcription data and displaying the LLM outputs); and
(3) Incorporating live ticket data from an incident management (e.g. ServiceNow) incident database.

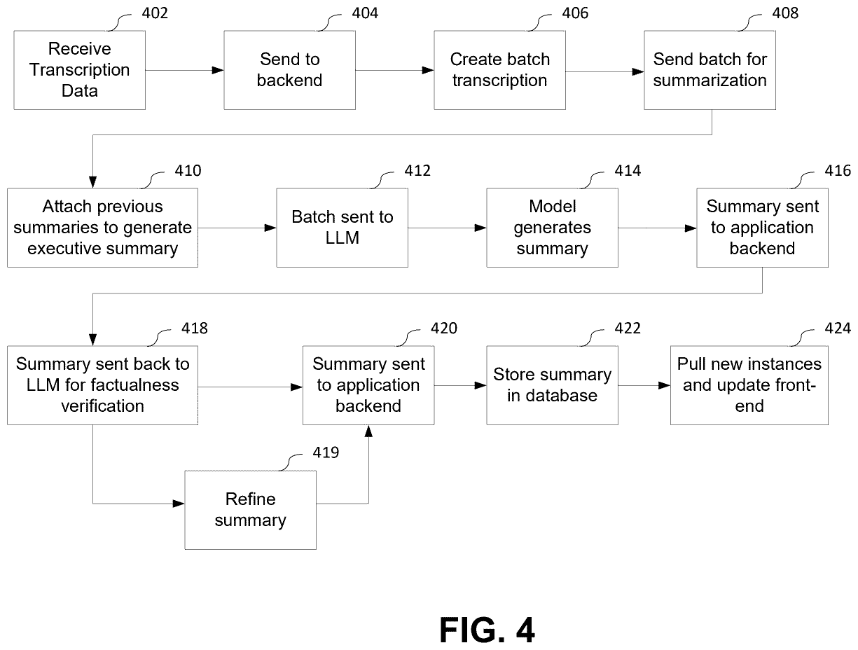

FIG. 4 shows a process flow diagram of the call analysis system.

Transcription data is received (402). For example, for a Webex™ meeting, the Webex transcriptions may be captured by a Webex browser SDK in real-time. The transcription data is sent to the application back-end (404) (e.g. a Fast API server via WebSocket). In addition, other data inputs, for example other forms of communication channels such as Confluence™, Slack™, email, etc., and/or multimodal inputs in addition to the voice transcripts, such as application logs, error messages, alerts, chat texts, and images, may be obtained and sent to the application back-end for use in the call analysis.

A batch of the transcription data is created (406). As described above, the transcription data may be batched based on a batch time period or a batch data size, which helps to analyze the call data more quickly and enable real-time/near-real-time analysis. The batch of transcription data is provided to a large language model (e.g. through an LLM gateway) for summarization with an associated prompt to generate a summary of the call for the batch of transcription data (408). The summary of the call may comprise an identification of key events, which may for example be considered as actions and/or decisions that have taken place toward solving the problem, such as attempted solutions, a decision of a root cause, etc. For example, an event may be a confirmation that error logs have been checked. An exemplary prompt to the LLM for summarizing a document comprising the batched transcription data is as follows:

Provide a summary with a maximum of 3 key events using the provided ‘document’, which is a conversation in text. Each conversation summary should be 20 words or less. If you cannot provide a summary with the given context do not return anything.

The batched transcription data for summarization may also be provided along with previously generated summaries for a plurality of batches of transcription data (410). The LLM may be prompted to generate an ongoing executive summary of the call based on the previously generated summaries and the current batch of transcription data. An exemplary prompt to the LLM for generating an executive summary is as follows:

Provide an executive summary using the provided document in 60 words or less. You cannot refer to any information outside of the prompt.

Accordingly, the batched transcription data, additional communication channel data and/or multimodal inputs, and any previously generated summaries of the call are provided to the LLM through the LLM gateway along with the applicable prompts to the LLM (412). The LLM generates the summary of the call based on the batched transcription data and an ongoing executive summary of the call (414), which is returned to the application backend (416).

The LLM may be prompted to adopt risk personas. Examples of prompts for risk personas are provided as follows:

(1) You are an IT incident Scribe. Respond to the query like how an IT incident Scribe would. You cannot refer to any information outside of the prompt.
(2) You are an IT risk manager. Respond to the query like using the question prompts listed under ##Questions##. You cannot refer to any information outside of the prompt. If you cannot answer a question then say that you do not have that information.
##questions##
1. Was this incident triggered by an alert and were correct teams alerted?
2. Did restoration actions ensure stability?
3. Were there any gaps in the incident response process?
4. Is there a chance or re-occurrence?
5. Was the incident caused by a recent change?
6. Is this incident part of an existing problem investigation?
7. Was the incident caused by a known error?
8. Were there any workarounds put in place to restore service?
9. Is there a single point of failure identified?
10. Was moving to disaster recovery considered? If so were there any challenges encountered?

The call analysis tool may also implement a chain-of-verification technique to verify the factualness of the created summary of the call (e.g. both on the summary of the call based on the batched transcription data and on the ongoing executive summary) and thereby reduce hallucination. In this example, the chain-of-verification technique uses a list of verification questions (created by the model itself) to confirm that all questions can get answered to thereby verify the accuracy of generated summary of the call. The summary of the call, along with the appropriate prompts, may thus sent back to the LLM for factualness verification (418). An exemplary prompt to generate a list of verification questions is as follows:

Use ‘document’ to generate a list of verification questions. The verification questions are meant for verifying the factual accuracy in the baseline response. Return output as a numbered list of verification questions in the format [verification questions]\n. Do not include brackets. Produce a minimum of 5 and a maximum of 7 questions, and make each questions 15 words or less.

An exemplary prompt for performing the verification is as follows: Given ‘document’, answer the questions in ‘verification questions’. The questions could be tricky as well, so think step by step and answer them correctly. Focus on identifying inconsistencies. Return output in the format [Answer]\n. Do not include brackets. Do not refer to any information outside of what was provided.

If factual errors are found from the factualness verification, then the summary is refined (419). An exemplary prompt to refine the summary of the call is as follows:

Analyze the given ‘verification questions’ to refine ‘baseSummary’ using ‘transcript’. Keep the summary to a maximum of 5 sentences, each sentence a maximum of 20 words. Focus on factuality in the summarized response. Do not use any information outside of what was given.

The verified/refined summary of the call is returned back to the application backend (420). The summary of the call is stored in a database (e.g. a Mongo database instance) (422). The server pulls new instances as they are updated in the database and updates the front-end application for display of the new information (424). The server may also generate detailed reports on incident activity for risk, strategy, compliance, and/or regulatory reporting.

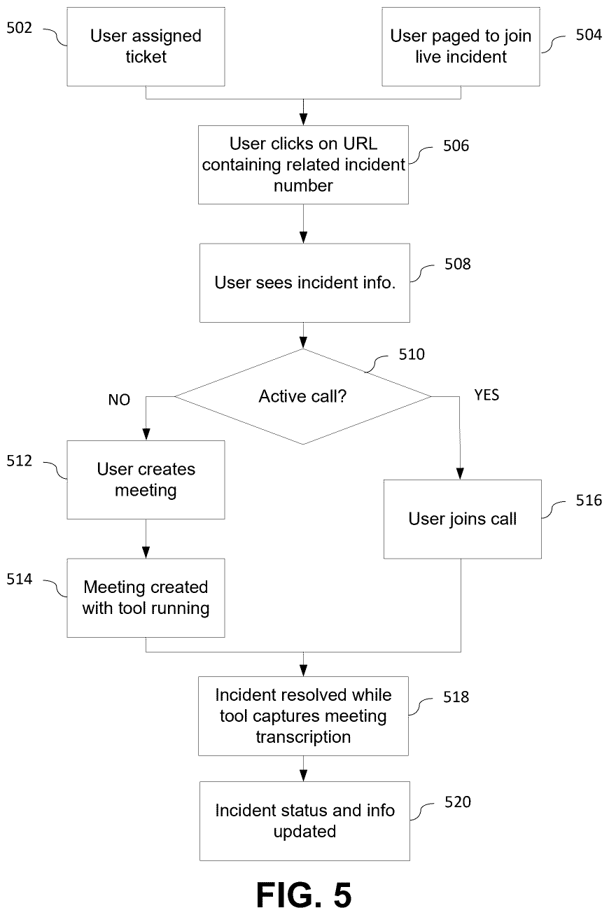

FIG. 5 shows an example of a user flow diagram of how a user interacts with the call analysis system. In this example, a user is notified of an incident and the user engages in resolving the incident using a meeting platform to resolve the incident during a call.

Contact with a user may be initiated when the user is assigned an incident ticket for an application they are responsible for (502), for example in ServiceNow™, or the user may be paged to join a live incident impacting their application (504), for example by PagerDuty™. The communication to the user may contain a URL for the related incident, and when the user clicks on the URL (506) the user is brought to a landing page that displays incident information (508) including a current status of the incident, a sequence of events to-date, etc.

A determination is made as to whether there is an active call (e.g. a Webex™ call) in progress (510). If there is no active call in progress (NO at 510), the user may be presented with a button within the user interface to create a meeting (512), and the meeting is created with the call analysis tool running/present (514). If there is an active call in progress (YES at 510), the user may be presented with a “Join Meeting” button and the user joins the call (516). The user's browser is redirected to join the call (e.g. within a Webex™ platform). A chatbot interface may also be provided to allow natural language querying of events captured during the incident resolution meeting, which would enable newcomers to the call to interact with and query what has already transpired throughout the incident call, eliminating time taken away from resolution efforts by current involved members.

During the call, participants discuss the incident response and ideally resolve the incident while the call analysis tool captures the meeting transcription data (518). The call analysis tool performs call analysis in real-time as described herein, and the incident status and incident information can be updated and presented as the meeting unfolds (520). The meeting may be ended once the incident is resolved.

FIGS. 6A-E show examples of user interfaces that may be displayed by the call analysis system.

FIG. 6A shows an example of a user interface 600 that a user may be presented with when viewing information about a new incident. For example, the user interface 600 may be presented on a landing page after a user clicks a URL associated with an incident notification. As seen in the user interface 600, the current incident is that PagerDuty is unable to send notification messages. An initial Executive Summary before the meeting starts may display the same content as what is in a short description field in a ServiceNow ticket. As seen in the user interface 600, there is no ongoing Webex meeting. A user may click the launch button to create a meeting.

FIG. 6B shows an example of an alternative user interface 610 that a user may be presented with when viewing information about a new incident. In this example, there is an ongoing meeting in progress, and a user may click the join button to join the meeting.

FIG. 6C shows an example of a user interface 620 that a user may be presented with during the meeting. As seen in the user interface 620, the meeting transcriptions are currently being summarized as the meeting is ongoing. The executive summary may also be updated as the meeting transcriptions are being summarized. The user may stop or leave the meeting.

FIG. 6D shows an example of a user interface 630 upon clicking on the Timeline tab. As seen in the user interface 630, a timeline showing a sequence of events generated from the call summaries is presented.

FIG. 6E shows an example of a user interface 640 for another incident type upon clicking on the Learnings tab. As seen in the user interface 640, key takeaways from a call can be presented to a user.

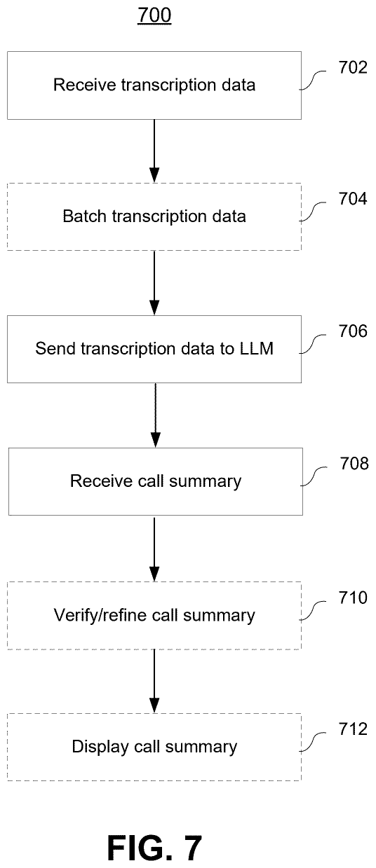

FIG. 7 shows a call analysis method 700 in accordance with the present disclosure. The call analysis method 700 is a computer-implemented method that may be implemented by the one or more servers 108 of FIG. 1. Code for executing the method may be stored on a non-transitory computer-readable medium as computer-executable instructions which, when executed by one or more processing devices, configure the processing devices to implement the method 700.

The method 700 comprises receiving transcription data for a call (702). The call may take place in an online meeting platform, and the transcription data may be received from a transcription application that sits in the meeting platform. The transcription data comprises text snippets corresponding to spoken words during the call and an associated user identifier corresponding to a participant in the call. The transcription data is preferably received in real-time during the call.

The transcription data is provided to a large language model with an associated prompt to generate a summary of the call based on the transcription data (706). Further, in some embodiments, multimodal inputs may be provided to the large language model along with the transcription data for generating the summary of the call. In some embodiments, the call is an incident resolution call and the generating the summary of call also comprises determining, using the large language model, one or more incident resolution events and generating a timeline of the one or more incident resolution events.

In some embodiments, the transcription data sent to the LLM is a batch of transcription data (i.e. a batch of transcript snippets) that is batched based on a batch time period or a batch data size. Batching the transcription data helps to enable near-real-time summarization of the call. Accordingly, the method 700 may further comprise batching the transcription data (704). In particular, a batch of transcription data may be created in real-time during the call, and the batch of transcription data sent to the large language model upon creation of the batch. A plurality of batches of transcription data may be provided sequentially (i.e. upon creation) to the large language model during the course of the call.

Moreover, a batch of transcription data may be sent to the LLM along with previously created summaries of the call generated for previously sent batches of transcription data, and the LLM may be prompted to generate an executive summary of the call based on a current batch of the transcription data and the previously generated summaries of the call.

The summary of the call output from the large language model is received (708). The summary of the call may be a summary generated based on a batch of the transcription data. An ongoing executive summary of the call may also be received. Over the course of the call, a plurality of summaries of the call based on the plurality of batches of transcription data may be received.

In some embodiments, the method may further comprise verifying and refining the summary of the call (710) using a chain-of-verification technique. Verifying and refining the summary may be performed by providing the summary of the call back to the large language model with questions for factualness verification and summary refining. The executive summary of the call may also be verified/refined.

The method may further comprise displaying the summary of the call in near-real-time in a user interface (712). A call summary generated based on a batch of transcription data may be displayed as it is received. The ongoing executive summary may also be displayed. A timeline of key events may also be displayed. The summary of the call may be stored in a database for subsequent analysis.

While the present disclosure specifically contemplates generating call summaries for meetings pertaining to incident resolution, it will be appreciated that the methods, systems, and techniques for call analysis as disclosed herein are not limited to such and that there are various applications in which it would be desirable to analyze and summarize calls.

Moreover, it will be appreciated that generating and storing call summaries helps to not only avoid information loss, but can also be used in various downstream learning applications such as to train AI models for a variety of applications, for example root cause analysis, self-healing, etc. Accordingly, call summaries may be stored in a format for effective retrieval in future LLM applications (e.g. as vector embeddings). In the context of incident resolution applications, technical context may be added to better comprehend the “why” and “how” behind the problem-solving process. For example, such technical context may include information related to the system(s) impacted by the incident, such as application code, implementation details, telemetry, observability inputs, etc., which would thus provide greater context to the LLM. Further, takeaways from an incident can be used to provide insight into other incidents and make relations, and connections may be built between incidents, systems, platforms, and applications to build cognitive abilities and identify preventative resolution abilities. Accordingly, root causes may be automatically determined and problem tickets may be automatically issued. Further, incident summaries may be used to determine and execute automated resolution procedures. It will thus be appreciated that the call analysis systems and methods disclosed herein can be provided as part of a platform that is accessible by other technologies and serves as a high-quality source of data.

As can be seen from the above description, the present disclosure is directed to the resolution of a computer problem to allow for automated call analysis in real-time during a call. Features of the methods, systems, and techniques for call analysis as described herein enable automated call analysis that obviates existing techniques for manually recording information during calls and/or manually parsing a transcript of a call. Importantly, however, the present disclosure is not merely directed to the automation of manual process by a generic computer processing, but rather describes specific functional computer technology that enables the automation of call analysis, which exists only in the context of operational computer systems.

The processor used in the foregoing embodiments may comprise, for example, a processing unit (such as a processor, microprocessor, or programmable logic controller) or a microcontroller (which comprises both a processing unit and a non-transitory computer readable medium). Examples of computer readable media that are non-transitory include disc-based media such as CD-ROMs and DVDs, magnetic media such as hard drives and other forms of magnetic disk storage, semiconductor based media such as flash media, random access memory (including DRAM and SRAM), and read only memory. As an alternative to an implementation that relies on processor-executed computer program code, a hardware-based implementation may be used. For example, an application-specific integrated circuit (ASIC), field programmable gate array (FPGA), system-on-a-chip (SoC), or other suitable type of hardware implementation may be used as an alternative to or to supplement an implementation that relies primarily on a processor executing computer program code stored on a computer medium.

The embodiments have been described above with reference to flow, sequence, and block diagrams of methods, apparatuses, systems, and computer program products. In this regard, the depicted flow, sequence, and block diagrams illustrate the architecture, functionality, and operation of implementations of various embodiments. For instance, each block of the flow and block diagrams and operation in the sequence diagrams may represent a module, segment, or portion of code, which comprises one or more executable instructions for implementing the specified action(s). In some alternative embodiments, the action(s) noted in that block or operation may occur out of the order noted in those figures. For example, two blocks or operations shown in succession may, in some embodiments, be executed substantially concurrently, or the blocks or operations may sometimes be executed in the reverse order, depending upon the functionality involved. Some specific examples of the foregoing have been noted above but those noted examples are not necessarily the only examples. Each block of the flow and block diagrams and operation of the sequence diagrams, and combinations of those blocks and operations, may be implemented by special purpose hardware-based systems that perform the specified functions or acts, or combinations of special purpose hardware and computer instructions.

The terminology used herein is for the purpose of describing particular embodiments only and is not intended to be limiting. Accordingly, as used herein, the singular forms “a”, “an”, and “the” are intended to include the plural forms as well, unless the context clearly indicates otherwise (e.g., a reference in the claims to “a challenge” or “the challenge” does not exclude embodiments in which multiple challenges are used). It will be further understood that the terms “comprises” and “comprising”, when used in this specification, specify the presence of one or more stated features, integers, steps, operations, elements, and components, but do not preclude the presence or addition of one or more other features, integers, steps, operations, elements, components, and groups. Directional terms such as “top”, “bottom”, “upwards”, “downwards”, “vertically”, and “laterally” are used in the following description for the purpose of providing relative reference only, and are not intended to suggest any limitations on how any article is to be positioned during use, or to be mounted in an assembly or relative to an environment. Additionally, the term “connect” and variants of it such as “connected”, “connects”, and “connecting” as used in this description are intended to include indirect and direct connections unless otherwise indicated. For example, if a first device is connected to a second device, that coupling may be through a direct connection or through an indirect connection via other devices and connections. Similarly, if the first device is communicatively connected to the second device, communication may be through a direct connection or through an indirect connection via other devices and connections. The term “and/or” as used herein in conjunction with a list means any one or more items from that list. For example, “A, B, and/or C”means “any one or more of A, B, and C”.

It is contemplated that any part of any aspect or embodiment discussed in this specification can be implemented or combined with any part of any other aspect or embodiment discussed in this specification.

The scope of the claims should not be limited by the embodiments set forth in the above examples, but should be given the broadest interpretation consistent with the description as a whole.

It should be recognized that features and aspects of the various examples provided above can be combined into further examples that also fall within the scope of the present disclosure. In addition, the figures are not to scale and may have size and shape exaggerated for illustrative purposes.

1. A call analysis method, comprising:
receiving transcription data for a call;
providing the transcription data to a large language model with an associated prompt to generate a summary of the call based on the transcription data; and
receiving the summary of the call output from the large language model.

2. The method of claim 1, wherein the transcription data is received in real-time during the call.

3. The method of claim 1, wherein the transcription data comprises text snippets corresponding to spoken words during the call and an associated user identifier corresponding to a participant in the call.

4. The method of claim 1, wherein the transcription data comprises a batch of transcription data that is batched based on a batch time period or a batch data size.

5. The method of claim 4, wherein the batch of transcription data is sent to the large language model upon creation of the batch.

6. The method of claim 5, wherein the batch of transcription data is created in real-time during the call.

7. The method of claim 4, further comprising providing a plurality of batches of transcription data to the large language model, and receiving a plurality of summaries of the call based on the plurality of batches of transcription data.

8. The method of claim 7, wherein the plurality of batches of transcription data are provided to the large language model sequentially upon creation of respective batches of transcription data.

9. The method of claim 7, further comprising prompting the large language model to generate an executive summary of the call based on the plurality of summaries of the call.

10. The method of claim 1, further comprising verifying the summary of the call by providing the summary of the call back to the large language model with questions for factualness verification and summary refining.

11. The method of claim 1, further comprising displaying the summary of the call in near-real-time in a user interface.

12. The method of claim 1, further comprising providing multimodal inputs to the large language model along with the transcription data for generating the summary of the call.

13. The method of claim 1, wherein the call is an incident resolution call.

14. The method of claim 13, further comprising determining, using the large language model, one or more incident resolution events, and generating a timeline of the one or more incident resolution events.

15. The method of claim 1, further comprising storing the summary of the call in a database.

16. The method of claim 1, wherein the call takes place on an online meeting platform.

17. The method of claim 1, wherein the transcription data is received from a transcription application.

18. A call analysis system, comprising:
a processor; and
a non-transitory computer-readable memory having computer-executable instructions stored thereon, which when executed by the processor, configure the system to perform a call analysis method comprising:
receiving transcription data for a call;
providing the transcription data to a large language model with an associated prompt to generate a summary of the call based on the transcription data; and
receiving the summary of the call output from the large language model.

19. The call analysis system of claim 18, further comprising a database for storing the summary of the call.

20. A non-transitory computer-readable memory having computer-executable instructions stored thereon, which when executed by a processor, configure the processor to perform a call analysis method comprising:
receiving transcription data for a call;
providing the transcription data to a large language model with an associated prompt to generate a summary of the call based on the transcription data; and
receiving the summary of the call output from the large language model.
